(19) United States
(12) Patent Application Publication
(10) Pub. No.: US 2026/0227720 A1
(43) Pub. Date: Aug. 6, 2026

(54) MAGNETIC ONE-COMPONENT TONER

(71) Applicant: KYOCERA Document Solutions Inc., Osaka (JP)

(72) Inventors: Seiji KIKUSHIMA, Osaka (JP); Kento FURUTA, Osaka (JP); Toshiki TAKEMORI, Osaka (JP); Ryo YAMADA, Osaka (JP); Masashi YAMASHITA, Osaka (JP); Masanori SUGAHARA, Osaka (JP)

(73) Assignee: KYOCERA Document Solutions Inc., Osaka (JP)

(21) Appl. No.: 19/456,787

(22) Filed: Jan. 22, 2026

(30) Foreign Application Priority Data
Feb. 4, 2025 (JP) 2025-016956

(51) Int. Cl. G03G 9/093; G03G 9/083; G03G 9/087

(52) U.S. Cl. CPC G03G 9/09342; G03G 9/083; G03G 9/08755

(57) ABSTRACT

Magnetic one-component toner includes a toner base particle containing a binder resin and a magnetic powder, and an external additive attached to the toner base particle. The external additive contains first and second silica particles with positive and negative chargeability, respectively, to non-coated ferrite carrier. When 10 g of non-coated ferrite carrier and 0.1 g of silica particles are weighed in a plastic bottle of 10 mL and mixed to determine the charge amounts after mixing for one minute and 10 minutes as an initial and an after-mixing charge amount, respectively, the ratio of the absolute value of the initial charge amount of the second silica particles to that of the first silica particles is 10% to 50%; the falling and rising rates of the after-mixing charge amount to the initial charge amount of the first and second silica particles, respectively, are both 20% to 50%.

### INCORPORATION BY REFERENCE

This application is based on and claims the benefit of priority from Japanese Patent Application No. 2025-016956 filed on Feb. 4, 2025, the contents of which are hereby incorporated by reference.

### BACKGROUND

The present disclosure relates to magnetic one-component toner.

In general, in electrophotography, the surface of an electrostatic latent image carrying member is electrostatically charged by corona discharge or the like and is then exposed to laser light or the like to form an electrostatic latent image. The formed electrostatic latent image is developed with toner to form a toner image. The formed toner image is then transferred to a recording medium to obtain a high-quality image.

Known methods for developing the electrostatic latent image with toner include: magnetic one-component development method, which uses only magnetic toner; and two-component development method, which uses two-component developer containing non-magnetic toner and magnetic carrier. Since magnetic toner is inexpensive compared with two-component developer, magnetic one-component development method is commonly used in monochrome printers.

The magnetic toner has a toner base particle containing a binder resin and a magnetic powder, and has an external additive attached to the surface of the toner base particle. Silica used as the external additive plays an important role in controlling the amount of charge of toner. Silica tends to induce change of the charge amount; positively chargeable silica in particular tends to have increasingly low positive charge over time. This causes a drop of or a change in the charge amount of toner, leading to background fogging (image fogging).

### SUMMARY

According to one aspect of the present disclosure, magnetic one-component toner has a toner particle including a toner base particle and an external additive attached to the surface of the toner base particle. The toner base particle contains at least a binder resin and a magnetic powder. The external additive contains first silica particles with positive chargeability with respect to non-coated ferrite carrier and second silica particles with negative chargeability with respect to the non-coated ferrite carrier. When 10 g of the non-coated ferrite carrier and 0.1 g of the silica particles are weighed in a plastic bottle of 10 mL and mixed using a Turbula Shaker-Mixer to determine the charge amount after mixing for one minute as an initial charge amount, and the charge amount after mixing for 10 minutes as an after-mixing charge amount, the ratio of the absolute value of the initial charge amount of the second silica particles to that of the first silica particles is 10% to 50%, and the falling rate of the after-mixing charge amount to the initial charge amount of the first silica particles and the rising rate of the after-mixing charge amount to the initial charge amount of the second silica particles are both 20% to 50%.

### DETAILED DESCRIPTION

A description will be given below of an embodiment according to the present disclosure. Unless otherwise defined, a result of evaluation (i.e., a value related to a shape, property, or the like) with respect to a powdery substance (specifically, toner core particle, toner base particle, external additive, toner, and the like) is given as a number average of values obtained by measuring respectively for an appropriate number of average particles selected from the powdery substance. Unless otherwise defined, a measured value of the number average particle size of a powdery substance or the volume median diameter (D50) of a powdery substance is a value measured using a Multisizer 4 (manufactured by Beckman Coulter, Inc.). Unless otherwise defined, a measured value of an acid number or a hydroxy group number is a value measured in conformity with JIS (Japanese Industrial Standards) K0070-1992. Unless otherwise defined, a measured value of a number average molecular weight (Mn) or a mass average molecular weight (Mw) is a value measured by gel permeation chromatography.

In the following description, “-based” is occasionally appended to the name of a compound to collectively refer to that substance and their derivatives. Whenever the name of a compound has “-based” appended to it to refer to the name of a polymer, the repeating unit in the polymer is derived from any of that compound and their derivatives. The term “(meth)acrylic” is occasionally used to refer to “acrylic” and “methacrylic” collectively. The term “(meth)acryloyl” is occasionally used to refer to “acryloyl” (CH₂═CH—CO—) and “methacryloyl” (CH₂═C(CH₃)—CO—) collectively.

Toner according to the embodiment can be used as positively chargeable toner suitably for development of electrostatic latent images. The toner according to the embodiment is a powdery substance containing a plurality of toner particles (each a particle configured as described later). The toner contains a magnetic powder and is used as one-component developer.

The toner particles of the toner according to the embodiment have a toner base particle and an external additive attached to the surface of the toner base particle. That is, the toner particle before the external additive attaches to it is referred to as toner base particle.

The toner according to the embodiment can be used to form an image, for example, on an electrophotographic apparatus (image forming apparatus). One example of an image forming method on an electrophotographic apparatus will be described below.

First, based on image data, an electrostatic latent image is formed on a photosensitive member (e.g., a superficial part of a photosensitive drum). Next, the formed electrostatic latent image is developed with magnetic one-component toner. In the development process, toner (e.g., toner electrostatically charged by friction with a blade) on a development sleeve (e.g., a superficial part of a development roller in a developing device) disposed near the photosensitive member is attached to the electrostatic latent image to form a toner image on the photosensitive member. In the subsequent transfer process, the toner image on the photosensitive member is directly transferred to a recording medium (e.g., sheet); or it is primarily transferred to an intermediate transfer member (e.g., a transfer belt) and then the toner image on the intermediate transfer member is secondarily transferred to the recording medium. Then, the toner is heated to fix the toner to the recording medium. As a result, an image is formed on the recording medium.

### [Basic Configuration of Toner]

The magnetic one-component toner according to the present disclosure (hereinafter also referred to simply as the toner) has a toner base particle and an external additive attached to the surface of the toner base particle. The toner base particle at least contains a binder resin and a magnetic powder. As necessary, the toner base particle can also contain, in the binder resin, a release agent, a colorant, a charge control agent, and the like.

The toner according to the present disclosure has two or more types of silica particles as the external additive. The silica particles include silica particles (first silica particles) with positive chargeability and silica particles (second silica particles) with negative chargeability with respect to non-coated ferrite carrier.

As mentioned previously, positively chargeable silica particles tend to have increasingly low positive charge over time. This causes a drop of or a change in the charge amount of toner, leading to background fogging. An effective way to suppress this change is to use, in combination with it, silica particles that has increasingly high positive chargeability (increasingly low negative chargeability) over time. In addition, to obtain appropriate positive chargeability requires giving consideration to the magnitudes (ratio) of positive and negative charge amounts of silica particles.

In the embodiment, the ratio of the absolute value of the initial charge amount of the second silica particles to that of the first silica particles is 10% to 50%, and it has been found that setting the falling rate of the charge amount of the first silica particles and the rising rate of the charge amount of the second silica particles between before and after mixing both to 20% to 50% helps suppress the drop in the positive charge of the silica particles. In that way, it is possible to provide magnetic one-component toner that can achieve sufficient image density without causing background fogging in the output image despite changes in the environment such as temperature and humidity or in the output pattern of images.

### [2. Material of Toner]

Now, a description will be given of, one by one, the binder resin, the magnetic powder, the release agent, the colorant, and the charge control agent that form the toner base particle, and the external additive externally added to the toner base particle.

### (Binder Resin)

The toner base particle that forms the toner according to the present disclosure contains a binder resin. The binder resin that can be contained in the toner base particle is not particularly limited so long as it is a resin that is known to be used as a binder resin in toner. Specific examples of the binder resin include thermoplastic resins such as styrene-based resins, acrylic-based resins, styrene-acrylic-based resins, polyethylene-based resins, polypropylene-based resins, vinyl chloride-based resins, polyester resins, polyamide resins, polyurethane resins, polyvinyl alcohol-based resins, vinyl ether-based resins, N-vinyl-based resins, and styrene-butadiene resins. Among these resins, in terms of the dispersion properties of the colorant in the binder resin, the charging properties of the toner, and the fixing properties to sheets, preferably, at least one of a polyester resin and a styrene-acrylic-based resin is used, more preferred being a polyester resin. The polyester resin will be described below.

Usable as polyester resins are those obtained by condensation polymerization or condensation copolymerization of a dihydric or a trihydric or higher alcohol component and a divalent or a trivalent or higher carboxylic acid component. Examples of components used to synthesize a polyester resin include alcohol components or carboxylic acid components as mentioned below.

Specific examples of dihydric or trihydric or higher alcohol components include: diols such as ethylene glycol, diethylene glycol, triethylene glycol, 1,2-propylene glycol, 1,3-propylene glycol, 1,4-butanediol, neopentyl glycol, 1,4-butenediol, 1,5-pentanediol, 1,6-hexanediol, 1,4-cyclohexanedimethanol, dipropylene glycol, polyethylene glycol, polypropylene glycol, and polytetramethylene glycol; bisphenols such as bisphenol A, hydrogenated bisphenol A, polyoxyethylene bisphenol A, and polyoxypropylene bisphenol A; and trihydric or higher alcohols such as sorbitol, 1,2,3,6-hexanetetrol, 1,4-sorbitan, pentaerythritol, dipentaerythritol, tripentaerythritol, 1,2,4-butanetriol, 1,2,5-pentanetriol, glycerol, diglycerol, 2-methylpropanetriol, 2-methyl-1,2,4-butanetriol, trimethylolethane, trimethylolpropane, and 1,3,5-trihydroxymethylbenzene.

Specific examples of divalent or trivalent or higher carboxylic acid components include divalent carboxylic acids such as maleic acid, fumaric acid, citraconic acid, itaconic acid, glutaconic acid, phthalic acid, isophthalic acid, terephthalic acid, cyclohexane dicarboxylic acid, succinic acid, adipic acid, sebatic acid, azelaic acid, and malonic acid, and alkyl or alkenyl succinic acids such as n-butyl succinic acid, n-butenyl succinic acid, isobutyl succinic acid, isobutenyl succinic acid, n-octyl succinic acid, n-octenyl succinic acid, n-dodecyl succinic acid, n-dodecenyl succinic acid, isododecyl succinic acid, and isododecenyl succinic acid; and trivalent or higher carboxylic acids such as, 1,2,4-benzenetricarboxylic acid (trimellitic acid), 1,2,5-benzene tricarboxylic acid, 2,5,7-naphthalene tricarboxylic acid, 1,2,4-naphthalene tricarboxylic acid, 1,2,4-butanetricarboxylic acid, 1,2,5-hexanetricarboxylic acid, 1,3-dicarboxyl-2-methyl-2-methylenecarboxypropane, 1,2,4-cyclohexane tricarboxylic acid, tetra (methylene carboxyl) methane, 1,2,7,8-octane tetracarboxylic acid, pyromellitic acid, and empole trimer acid. These divalent or trivalent or higher carboxylic acid components may be used as ester-forming derivatives such as acid halides, acid anhydrides, and lower alkyl esters. Here, the term “lower alkyl” denotes an alkyl group with one to six carbon atoms.

When the binder resin is a polyester resin, the softening point of the polyester resin is preferably 70° C. or more but 130° C. or less, and more preferably 80° C. or more but 120° C. or less. For improved mechanical strength of the toner base particle and improved fixing properties of the toner, the number average molecular weight (Mn) of the polyester resin is preferably 1000 or more but 2000 or less. The molecular weight distribution of the polyester resin (the ratio Mw/Mn of mass average molecular weight (Mw) to number average molecular weight (Mn)) is preferably 9 or more but 21 or less.

As the binder resin, it is preferable to use a thermoplastic resin for its satisfactory fixing properties to sheets. Here, a thermoplastic resin can be used not only singly but also with a cross-linking agent or a thermosetting resin added to it. Adding a cross-linking agent or a thermosetting resin so that the binder resin partly has a cross-linked structure helps improve the heat-resistant preservation properties, durability, and the like of the toner without degrading the fixing properties of the toner. When a thermosetting resin is used, the cross-linked fraction (gel fraction) of the binder resin extracted using a Soxhlet extractor is, with respect to the mass of the binder resin, preferably 10 mass % or less, and more preferably 0.1 mass % or more but 10 mass % or less.

As a thermosetting resin usable with a thermoplastic resin, an epoxy resin or a cyanate-based resin is preferred. Examples of suitable thermosetting resins include bisphenol A-type epoxy resins, hydrogenated bisphenol A-type epoxy resins, novolak-type epoxy resins, polyalkylene ether-type epoxy resins, cyclic aliphatic group-type epoxy resins, and cyanate resins. Two or more of these thermosetting resins can be used in combination.

The glass transition point (Tg) of the binder resin is preferably 40° C. or more but 70° C. or less. If the glass transition point is too high, the fixing properties of the toner at a low temperature tends to be poor. If the glass transition point is too low, the heat-resistant preservation properties of the toner tends to be poor.

The glass transition point of the binder resin can be determined from the changing point of the specific heat of the binder resin using a differential scanning calorimeter (DSC). More specifically, the glass transition point of the binder resin can be determined by plotting the endothermic curve of the binder resin using a differential scanning calorimeter (DSC-6200, manufactured by Seiko Instruments Inc.), as a measuring instrument. 10 mg of a measurement sample is put in an aluminum pan while an empty aluminum pan is used as a reference. From the endothermic curve of the binder resin plotted through measurement in a normal-temperature normal-humidity environment in the range of measurement temperature from 25° C. or more but 200° C. or less at a heating rate of 10° C. per minute, the glass transition point of the binder resin can be determined.

The mass average molecular weight (Mw) of the binder resin is not particularly limited within the scope consistent with the object of the present disclosure. Typically, the mass average molecular weight (Mw) of the binder resin is preferably 20,000 or more but 300,000 or less, and more preferably 30,000 or more but 200,000 or less. The mass average molecular weight of the binder resin can be determined by gel permeation chromatography (GPC) using a standard curve previously prepared using a standard polystyrene resin.

### (Magnetic Powder)

The toner base particle contains a magnetic powder in the binder resin. Suitably usable as a material of the magnetic powder is, for example, a ferromagnetic metal (more specifically, iron, cobalt, nickel, an alloy of one or more of these metals, or the like), a ferromagnetic metal oxide (more specifically, ferrite, magnetite, chromium dioxide, or the like), or a material subjected to ferromagnetization (more specifically, a carbon material made ferromagnetic by heat treatment, or the like). To suppress the elution of a metal ion (e.g., iron ion) from the magnetic powder, preferably, surface-treated magnetic particles are used as the magnetic powder. One type of magnetic powder can be used singly or a plurality of types of magnetic powder can be used in combination.

The particle size of the magnetic powder is not limited within the scope consistent with the object of the present disclosure. Specifically, the particle size of the magnetic powder is preferably 0.1 μm or more but 1.0 μm or less, and more preferably 0.1 μm or more but 0.5 μm or less. Using a magnetic powder with a particle size in those ranges makes it easy to disperse the magnetic powder in the binder resin.

As the magnetic powder, it is possible to use a product surface-treated using a surface treatment agent such as a titanium-based coupling agent or silane-based coupling agent for the purpose of improving the dispersion properties of the magnetic powder in the binder resin.

The amount of magnetic powder used is not particularly limited within the scope consistent with the object of the present disclosure. Specifically, the amount of magnetic powder used is preferably, relative to the total mass of the toner, 30 mass % or more but 60 mass % or less, and more preferably 40 mass % or more but 60 mass % or less. Using too large an amount of magnetic powder can make it difficult to form images with the desired image density for a long period, or can lead to extremely poor fixing properties of the toner to sheets. Using too small an amount of magnetic powder can cause fogging in the formed image, or can make it difficult to form images with the desired image density for a long period.

### (Release Agent)

For the purpose of improving its fixing properties and anti-offsetting properties, the toner base particle can contain a release agent. The type of release agent that can be added to the toner base particle is not limited. As such a release agent, wax is preferred. Examples of wax include carnauba wax, synthetic ester wax, polyethylene wax, polypropylene wax, fluorocarbon resin-based wax, Fischer-Tropsch wax, paraffin wax, montan wax, and rice wax. Two or more of these release agents can be used in combination. Adding such a release agent to the toner base particle helps more effectively suppress offsetting and image smearing (stain around an image caused by its being rubbed).

When a polyester resin is used as the binder resin, from the viewpoint of compatibility, as a release agent, one or more release agents selected from the group consisting of carnauba wax, synthetic ester wax, and polyethylene wax is suitably used. On the other hand, when a polystyrene-based resin is used as the binder resin, likewise from the viewpoint of compatibility, as a release agent, Fischer-Tropsch wax and/or paraffine wax is suitably used.

Fischer-Tropsch wax is a straight-chain hydrocarbon compound with few iso-structure molecules or side-chains that is produced by exploiting the Fischer-Tropsch reaction, which is a catalytic hydrogenation reaction of carbon monoxide.

Preferred among different types of Fischer-Tropsch wax are those that have a mass average molecular weight of 1,000 or more of which the bottom temperature of the endothermic peak observed by DSC measurement falls within the range of 100° C. or more but 120° C. or less. Examples of such types of Fischer-Tropsch wax include the following products available from Sasol Ltd.: Sasol Wax C1 (endothermic peak bottom temperature: 106.5° C.), Sasol Wax C105 (endothermic peak bottom temperature: 102.1° C.), Sasol Wax Spray (endothermic peak bottom temperature: 102.1° C.), and the like.

The amount of release agent used is not particularly limited within the scope consistent with the object of the present disclosure. Specifically, the amount of release agent used is, relative to the total mass of the toner base particle, preferably 1 mass % or more but 10 mass % or less. Using too small an amount of release agent can result in less-than-expected suppression of offsetting or image smearing in image formation; using too large an amount of release agent can result in fusing-together of toner particles and hence poor heat-resistant preservation properties of toner.

### (Colorant)

Containing a magnetic powder as an essential component, the toner base particle is generally black. Accordingly, within the scope consistent with the object of the present disclosure, for the purpose of obtaining a more preferred tone of black in the image formed using the toner according to the present disclosure, the toner can contain as a colorant any known dye or pigment. Specifically, one example of a pigment is carbon black and one example of a dye is an acid violet.

The amount of colorant used is not particularly limited within the scope consistent with the object of the present disclosure. Specifically, the amount of colorant used is preferably, relative to the total mass of the toner base particle, 1 mass % or more but 10 mass % or less, and more preferably 2 mass % or more but 7 mass % or less.

A colorant can be used as a master batch having a colorant previously dispersed in a resin material such as a thermoplastic resin. When a colorant is used as a master batch, the resin contained in the master batch is preferably a resin of the same type as the binder resin.

### (Charge Control Agent)

The toner base particle can contain a charge control agent for the purpose of improving the charge level of the toner and its charge response properties as an index of whether it can be charged to a predetermined charge level in a short time and thereby obtaining toner with excellent durability and stability. Since the toner according to the present disclosure is positively chargeable toner, a positively chargeable charge control agent is used.

The type of charge control agent that can be contained in the toner base particle is not particularly limited within the scope consistent with the object of the present disclosure. Any of charge control agents known to be used in toner can be appropriately selected and used. Specific examples of positively chargeable charge control agents include: azine compounds such as pyridazine, pyrimidine, pyrazine, orthoxazine, metaoxazine, paraoxazine, orthothiazine, metathiazine, parathiazine, 1,2,3-triazine, 1,2,4-triazine, 1,3,5-triazine, 1,2,4-oxadiazine, 1,3,4-oxadiazine, 1,2,6-oxadiazine, 1,3,4-thiadiazine, 1,3,5-thiadiazine, 1,2,3,4-tetrazine, 1,2,4,5-tetrazine, 1,2,3,5-tetrazine, 1,2,4,6-oxatriazine, 1,3,4,5-oxatriazine, phthalazine, quinazoline, and quinoxaline; direct dyes composed of azine compounds, such as azine fast red FC, azine fast red 12BK, azine violet BO, azine brown 3G, azine light brown GR, azine dark green BH/C, azine deep black EW, and azine deep black 3RL; nigrosine compounds, such as nigrosine, nigrosine salts, and nigrosine derivatives; acid dyes composed of nigrosine compounds, such as nigrosine BK, nigrosine NB, and nigrosine Z; metal salts of naphthenic acid or higher fatty acids; alkoxylated amines; alkylamides; and quaternary ammonium salts, such as benzylmethylhexyldecylammonium and decyltrimethylammonium chloride. Among these positively chargeable charge control agents, nigrosine compounds are particularly preferred for their faster charge response properties. Two or more of these positively chargeable charge control agents can be used in combination.

Also usable as a positively chargeable charge control agent are resins that have as a functional group a quaternary ammonium salt, a carboxylic acid salt, or a carboxyl group. Specific examples include styrene-based resin having a quaternary ammonium salt, acrylic-based resin having a quaternary ammonium salt, styrene-acrylic-based resin having a quaternary ammonium salt, polyester resin having a quaternary ammonium salt, styrene-based resin having a carboxylic acid salt, acrylic-based resin having a carboxylic acid salt, styrene-acrylic-based resin having a carboxylic acid salt, polyester resin having a carboxylic acid salt, styrene-based resin having a carboxylic group, acrylic-based resin having a carboxylic group, styrene-acrylic-based resin having a carboxylic group, and polyester resin having a carboxylic group. The molecular weight of these resins is not particularly limited within the scope consistent with the object of the present disclosure, and they can be in the form of an oligomer or a polymer.

Among resins usable as a positively chargeable charge control agent, from the viewpoint of easy adjustment of the amount of charge within a desired range, styrene-acrylic-based resin having as a functional group a quaternary ammonium salt is more preferred. Specific examples of preferred acrylic-based comonomers for copolymerization with the styrene unit in styrene-acrylic-based resin having as a functional group a quaternary ammonium salt include esters of alkyl (meth)acrylates such as methyl acrylate, ethyl acrylate, n-propyl acrylate, iso-propyl acrylate, n-butyl acrylate, iso-butyl acrylate, 2-ethylhexyl acrylate, methyl methacrylate, ethyl methacrylate, n-butyl methacrylate, and iso-butyl methacrylate.

Used as a quaternary ammonium salt is a unit derived by a quaternization process from a dialkyl aminoalkyl (meth)acrylate, dialkyl (meth)acryl amide, or dialkyl aminoalkyl (meth)acryl amide. Specific examples of dialkyl aminoalkyl (meth)acrylate include dimethylaminoethyl (meth)acrylate, diethyl aminoethyl (meth)acrylate, dipropyl aminoethyl (meth)acrylate, and dibutyl aminoethyl (meth)acrylate. Specific examples of dialkyl (meth)acrylamide include dimethyl methacryl amide. Specific examples of dialkyl aminoalkyl (meth)acrylamide include dimethyl aminopropyl methacrylamide. In polymerization, a polymerizable monomer containing the hydroxy group such as hydroxyethyl (meth)acrylate, hydroxypropyl (meth)acrylate, 2-hydroxybutyl (meth)acrylate, or N-methylol (meth)acrylamide can be used together.

The amount of charge control agent used is not particularly limited within the scope consistent with the object of the present disclosure. Typically, the amount of charge control agent used is, relative to the total mass of the toner core particle, preferably 0.1 mass % or more but 10 mass % or less. Using too small an amount of charge control agent makes it difficult to stably charge the toner with a predetermined polarity. This can lead to a lower-than-expected value in the image density of the formed image and make it difficult to maintain satisfactory image density for a long period. Also, the charge control agent is then difficult to disperse evenly, and this tends to cause fogging in the formed image and contamination of a latent image carrying member with toner components. Using too large an amount of charge control agent can lead to poorer resistance to environment and this tends to cause image faults in the formed image due to insufficient charging under high temperature and high humidity, contamination of a latent image carrying member with toner components, and the like.

### (External Additive)

The toner according to the present disclosure has a toner base particle of which the surface is treated with an external additive. The toner according to the present disclosure contains, as the external additive, first silica particles and second silica particles.

### (First Silica Particles)

The first silica particles have positive chargeability to non-coated ferrite carrier. That is, the first silica particles are higher than the non-coated ferrite carrier in the triboelectric series. Used as the first silica particles are those resulting from surface-treating dry silica particles with a hydrophobization agent such as an alkylsilane. Used as the dry silica particles are those (fumed silica) produced by a method involving gas-phase hydrolysis of halogenated silane such as silicon tetrachloride at high temperature (flame hydrolysis process), or those produced by a method involving vaporizing silica sand by reducing it with coke in an electric furnace and then oxidizing the produced gas (heating process).

Specific examples of alkylsilanes used as a hydrophobization agent include alkylhalosilanes (more specifically, trichloro(methyl) silane, dichlorodimethylsilane, chlorotrimethylsilane, tert-butyldimethylchlorosilane, and the like), phenylhalosilanes (more specifically, phenyltrichlorosilane, dichlorodiphenylsilane, and the like), vinylhalosilanes (more specifically, vinyltrichlorosilane and the like), tetraalkoxysilanes (more specifically, tetramethoxysilane, tetraetoxysilane, and the like), alkylalkoxysilanes (more specifically, trimethoxy(methyl) silane, dimethoxydimethylsilane, triethoxymethylsilane, diethoxydimethylsilane, isobutyltrimethoxysilane, decyltrimethoxysilane, and the like), alkylalkoxysilane halides (more specifically, 3-chloropropyltrimethoxysilane and the like), phenylalkoxysilanes (more specifically, trimethoxyphenylsilane, dimethoxydiphenylsilane, triethoxyphenylsilane, diphenyldiethoxysilane, and the like), vinylalkoxysilanes (more specifically, vinyltrimethoxysilane, vinyltriethoxysilane, and the like), silane coupling agents having a (meth)acryloyl group (more specifically, 3-(trimethoxysilyl) propyl methacrylate and the like), silane coupling agents having an epoxy group (more specifically, 2-(3,4-epoxycyclohexyl)ethyltrimethoxysilane, 3-glycidyloxypropyltrimethoxysilane, 3-glycidyloxypropylmethyldiethoxysilane, and the like), and silane coupling agents having a mercapto group (more specifically, 3-mercaptopropyltrimethoxysilane and the like). Using dry silica particles hydrophobized with a positively chargeable hydrophobization agent such as an aminosilane, which has an amino group introduced in a silane compound helps enhance the positive chargeability of the silica particles and makes it easy to suppress a drop in the charge amount of the toner under high-temperature high-humidity conditions.

Silicone oil can also be used as a hydrophobization agent for dry silica particles. The type of silicone oil is not particularly limited so long as it provides the desired hydrophobizing effect, and any of various silicone oils known to be used as a hydrophobization agent can be used. Silicone oil having a straight-chain siloxane structure is preferred, and both non-reactive and reactive silicone oil can be used. Specific examples of silicone oil include dimethylsilicone oil, phenylmethylsilicone oil, chlorophenylsilicone oil, alkylsilicone oil, chlorosilicone oil, polyoxyalkylene-modified silicone oil, fatty acid ester-modified silicone oil, methylhydrogen silicone oil, silanol group-containing silicone oil, alkoxy group-containing silicone oil, acetoxy group-containing silicone oil, amino-modified silicone oil, carboxylic acid-modified silicone oil, and alcohol-modified silicone oil.

### (Second Silica Particles)

The second silica particles have negative chargeability to non-coated ferrite carrier. That is, the second silica particles are lower than the non-coated ferrite carrier in the triboelectric series. Used as the second silica particles are those resulting from subjecting wet silica particles to hydrophobization treatment with a titanate coupling agent. The wet silica particles are produced by a method that synthesizes silica fine particles in wet form through hydrolysis of an alkoxysilane or a method like a precipitation process or a sol-gel process that produces silica fine particles in wet form from sodium silicate.

Examples of titanate coupling agents as the hydrophobization agent include isopropyltriisostearoyl titanate, dihydrogen bis(ditridecyl phosphito-O″)tetrakis(octan-1-olato)titanate, and the like.

Now, the charge amounts of the first and second silica particles will be described. The charge amounts of the first and second silica particles are measured through the following procedure. 10 g of non-coated ferrite carrier (EF-35, manufactured by Powdertech Co., Ltd.) and 0.1 g of silica particles are weighed in a plastic bottle of 10 mL. The charge amount after mixing for one minute using a Turbula Shaker-Mixer (manufactured by Shinmaru Enterprises Corporation) is taken as the initial charge amount; and the charge amount after mixing for 10 minutes is taken as the after-mixing charge amount. The carrier charge amount is measured using a charge amount measurement device (Q/m meter, Model 212HS, manufactured by TRek Inc.).

Here, the ratio of the absolute value of the initial charge amount of the second silica particles to that of the first silica particles is 10% to 50%, and, between before and after mixing, the falling rate of the charge amount of the first silica particles (falling rate of the after-mixing charge amount to the initial charge amount) and the rising rate of the charge amount of the second silica particles (rising rate of the after-mixing charge amount to the initial charge amount) are both 20% to 50%.

With the first and second silica particles having charge amounts satisfying the above conditions, a drop in the charge amount of the first silica particles with positive chargeability is cancelled out by a rise in the charge amount of the second silica particles with negative chargeability, so that the charge amount distribution in toner chains is narrowed to be stabilized. This prevents the charge amount distribution from spreading out with respect to the mixing state of toner, so that it is possible to maintain sufficient image density without causing background fogging in the output image despite changes in the environment such as temperature and humidity or in the output pattern.

Using wet silica particles as the base material of the second silica particles and subjecting the wet silica particles to hydrophobization treatment with a titanate coupling agent permits hydrophobization treatment without degrading the chargeability of the wet silica particles.

Specifically, when the rising rate of the charge amount (the rising rate of the after-mixing charge amount to the initial charge amount) before and after mixing of wet silica particles before hydrophobization treatment with the non-coated ferrite carrier is 20% to 50%, the rising rate of the charge amount of the second silica particles after hydrophobization treatment with a titanate coupling agent is also 20% to 50%. That is, the rising rate of the charge amount does not vary greatly before and after hydrophobization treatment. This allows easy adjustment of the charge amount of the second silica particles.

The external additive can contain, in addition to the first and second silica particles, any external additive other than silica particles. Preferred as another external additive is particles of a metal oxide (more specifically alumina, titanium oxide, magnesium oxide, zinc oxide, strontium titanate, barium titanate, or the like) or resin particles. The other external additive can be surface-treated.

### [3. Production Method for Toner]

Next, a production method for the toner according to the present disclosure will be described. The production method for the toner includes a production method for a toner base particle and an external additive treatment method for attaching an external additive to the surface of the toner base particle. The production method for the toner base particle is not particularly limited so long as it forms the toner base particle with a predetermined structure. As a production method suitable for the positively chargeable toner described above, a production method for the toner base particle and an external additive treatment method will be described one by one.

### (Production Method for Toner Base Particle)

The method for producing the toner base particle is not particularly limited so long as it can satisfactorily disperse a magnetic powder and any components such as a colorant, a release agent, and a charge control agent in the binder resin. Examples of suitable production methods for the toner base particle include a pulverization method.

In a pulverization method, the binder resin is mixed with the components such as the magnetic powder, colorant, release agent, and charge control agent using a mixer or the like; then the binder resin and the components blended in it are melted and kneaded using a kneader such as a uniaxial or biaxial extruder; and then the cooled kneaded product is pulverized and classified. The average particle size of the toner base particle is not particularly limited within the scope consistent with the object of the present disclosure; typically, it is preferably 5 μm or more but 10 μm or less.

### (External Additive Treatment Method)

The method for treating the toner base particle with the external additive is not particularly limited; the toner base particle can be treated by any known method. Specifically, the toner base particle is treated with the external additive using a mixer such as a Henschel mixer under treatment conditions adjusted so that the particles of the external additive do not sink into the toner base particle.

With the toner according to the present disclosure described above, when images are formed for a long period in various environments such as a high-temperature high-humidity environment and a low-temperature low-humidity environment, it is possible to stabilize the charge amount of the toner and thus to form images with the desired density. In addition, it is possible to effectively suppress image fogging after durability printing. Thus, the toner according to the present disclosure can be used suitably in various image forming apparatuses. Now, the effects of the present disclosure will be described more specifically by way of examples. The present disclosure is not limited in any way by those examples.

### EXAMPLES

### Production Example 1

### <Production of First Silica Particles A-1 to A-3>

### (1-1. Production of Silica Base A)

A silicon tetrachloride compound was introduced together with an inert gas in a mixing chamber of a combustion apparatus (burner). Hydrogen and air were further introduced to the mixing chamber, and the introduced gases were all combusted at 1200° C. to be reacted in a reaction chamber of the combustion apparatus. Then, at a combustion exhaust gas temperature of 450° C., using a filter with a pore size of 1 μm, 130 m²/g of silica base A was collected.

### (1-2. Production of First Silica Particles A-1)

20 g of triethoxy-n-octylsilane and 20 g of [3-(N,N-dimethylamino) propyl]trimethoxysilane (both manufactured by Shin-Etsu Chemical Co., Ltd.) were dissolved in 200 g of toluene to prepare a 10-times diluted solution. Then, while 200 g of silica base A obtained at 1-1 above was stirred, the diluted solution prepared as just mentioned was dropped into it little by little. The product was irradiated with ultrasound waves for 30 minutes and was stirred to obtain a mixture. The mixture was heated in a constant-temperature bath at 150° C., and then the toluene was evaporated using a rotary evaporator to obtain a solid, which was then dried in a vacuum drier at 50° C. until its weight no longer reduced. The product was then heated for three hours at 200° C. in a stream of nitrogen in an electric furnace. The obtained powdery substance was pulverized using a jet mill and was collected in a bag filter to obtain first silica particles A-1.

### (1-3. Production of First Silica Particles A-2)

200 g of silica base A obtained at 1-1 above was loaded in a reaction vessel, and a nitrogen gas was introduced to it to produce a nitrogen atmosphere. Then, 25 g of cyclic silazane represented by chemical formula (1) below and 15 g of hexamethyldisilazane were added continuously for 10 minutes. The product was stirred for 20 minutes. Then, the vessel was hermetically sealed in nitrogen to be left standstill for 16 hours at room temperature and was then heated at 90° C. for about 16 hours to obtain first silica particles A-2.

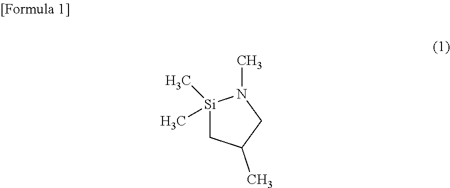

### (1-4. Production of First Silica Particles A-3)

First silica particles A-3 were obtained through a procedure similar to that for first silica particles A-1 except that, instead of 20 g of triethoxy-n-octylsilane and 20 g of [3-(N,N-dimethylamino) propyl]trimethoxysilane, 30 g of dimethylpolysiloxane and 15 g of 3-aminopropyltrimethoxysilane (both manufactured by Shin-Etsu Chemical Co., Ltd.) were used.

### [Production of Second Silica Particles B-1 to B-5]

### (2-1. Production of Silica Base B)

In a jacketed vessel of stainless steel with a volume of 2 L provided with a stirrer, two dropping nozzles, and a thermometer as well as with a circulation pump, an aqueous solution of sodium silicate No. 3 [SiO₂ concentration: 25 wt %, SiO₂/Na₂O mol ratio: 3.3) and a 40 wt % aqueous solution of sulfuric acid were mixed such that the excess sulfuric acid was 0.6N to obtain silica hydrosol. The silica hydrosol was left to stand still for a while to turn into gel. The product was hydrothermally processed for 12 hours under the conditions of 90° C. and a pH value of 9.5; then, to remove alkalis, sulfuric acid was added until the excess sulfuric acid was 0.03N. The product was then left to stand still for another one hour at 60° C. After that, the product was washed with water sufficiently to obtain silica hydrogel.

The obtained silica hydrogel was dried using a dryer until its moisture content was 10%, was then pulverized on a jet mill (PJM-100NP, manufactured by Nippon Pneumatic Mfg. Co., Ltd.) using superheated steam, and was classified using a wind-power classifier (Classeal N-5 manufactured by Seishin Enterprise Co., Ltd.) to obtain precipitated silica. The obtained precipitated silica was filtered using a filter press and was washed with water to obtain a silica cake. The obtained silica cake was turned into a slurry using a reciprocating rotary stirrer (Ajiter AP04, manufactured by Shimazaki Mixing Engineering Co., Ltd.). Then, to the silica, 2.0 mass % of polyoxyalkylenealkyl ether nonionic surfactant (Noigen XL-61, manufactured by DKS Co., Ltd.; HLB: 13) was added. The product was stirred once more, was then spray-dried under the condition of an outlet temperature of 110° C. using a disc-type spray dryer (Spray Dryer AN-40R, manufactured by Ashizawa Niroatomizer. Co.), was then pulverized using a jet mill, and was classified using a wind-power classifier to remove coarse particles to obtain silica base B.

### (2-2. Production of Second Silica Particles B-1)

15 g of isopropyltriisostearoyl titanate (manufactured by Ajinomoto Fine-Techno Co., Inc.) was dissolved in 200 g of toluene to prepare a 10-times diluted solution. Then, while 100 g of second silica base B obtained at 2-1 above was stirred, the diluted solution prepared as just mentioned was dropped into it little by little. The product was irradiated with ultrasound waves for 30 minutes and was stirred to obtain a mixture. The mixture was heated in a constant-temperature bath at 80° C., and then the toluene was evaporated using a rotary evaporator to obtain a solid, which was then dried in a vacuum drier at 50° C. until its weight no longer reduced. The product was then heated for three hours at 200° C. in a stream of nitrogen in an electric furnace. The obtained powdery substance was pulverized using a jet mill and was collected in a bag filter to obtain second silica particles B-1.

### (2-3. Production of Second Silica Particles B-2)

Second silica particles B-2 were produced through a procedure similar to that for second silica particles B-1 except that, instead of isopropyltriisostearoyl titanate, dihydrogen bis(ditridecyl phosphito-O″)tetrakis(octan-1-olato)titanate was used.

(2-4. Production of Second Silica Particles B-3) Second silica particles B-3 were produced through a procedure similar to that for second silica particles B-1 except that, instead of isopropyltriisostearoyl titanate, 2-cyanoethyltriethoxysilane was used.

### (2-5. Production of Second Silica Particles B-4)

Second silica particles B-4 were produced through a procedure similar to that for second silica particles B-1 except that, instead of isopropyltriisostearoyl titanate, octyltriethoxysilane was used.

### (2-6. Production of Second Silica Particles B-5)

Second silica particles B-5 were produced through a procedure similar to that for second silica particles B-1 except that, instead of isopropyltriisostearoyl titanate, 3,3,3-trifluoropropyltrimethoxysilane was used.

### Production Example 3

### (Production of Toner Base Particles)

As a binder resin, 1100 g of polyester resin A (manufactured by Kao Corporation, Mw: 6500, acid value: 8.2 mgKOH/g, Tm: 96.3° C., Tg: 54.4° C.), 1090 g of polyester resin B (manufactured by Kao Corporation, acid value: 11.8 mgKOH/g, Tm: 118.5° C., Tg: 59.6° C., a gel fraction of 36%), 1450 g of a magnetic powder (MRO-15A, manufactured by Toda Kogyo Corporation), 200 g of a charge control agent (FCA-201-PS, manufactured by Fujikura Kasei Co., Ltd.), and 160 g of a release agent (Carnauba Wax No. 1 manufactured by S. Kato and Co.) were mixed for five minutes at a rotation rate of 2000 rpm using an FM mixer (FM-20B, manufactured by Nippon Coke & Engineering Co., Ltd.) to obtain a mixture.

The obtained mixture was melted and kneaded using a biaxial extruder (TEM-26SS, manufactured by Toshiba Machine Co., Ltd.) to obtain a kneaded product. The melting and kneading were performed under the conditions of a cylinder temperature of 120° C., a spindle rotation rate of 100 rpm, and a processing rate of 75 g/min. The kneaded product was cooled and was then coarsely pulverized using a pulverizer (Rotoplex 16/8, manufactured by Hosokawa Micron Corporation). The obtained coarsely pulverized product was then pulverized using a mechanical pulverizer (Turbomill TA, manufactured by Freund-Turbo Corporation) to obtain a pulverized product. The pulverized product was finely pulverized using a jet mill (MJT-1, manufactured by Hosokawa Micron Corporation) and was classified to obtain toner base particles with a number average primary particle size of 8.0 μm.

### Production Example 4

### (Production of Toner)

To 1.8 kg of the toner base particles obtained in production example 3, 18 g of first silica particles A-1 obtained in production example 1 and 5.4 g of second silica particles B-1 obtained in production example 2 were added, and the mixture was mixed for 15 minutes at a rotation rate of 2000 rpm using an FM mixer (FM-10C, manufactured by Nippon Coke & Engineering Co., Ltd.) to attach (externally add) the silica particles to the toner base particles. Then, the product was sieved using a sieve shaker machine (VSS-200S, manufactured by Tsutsui Rikagaku kikai-sha), with a 100-mesh sieve (with 150 μm openings), to obtain toner of Practical Example 1 of the present disclosure.

The toner of Practical Example 2 was produced through a procedure similar to that for the toner of Practical Example 1 except that second silica particles B-2 were used instead of second silica particles B-1.

The toner of Practical Example 3 was produced through a procedure similar to that for the toner of Practical Example 1 except that first silica particles A-2 were used instead of first silica particles A-1.

The toner of Practical Example 4 was produced through a procedure similar to that for the toner of Practical Example 1 except that second silica particles B-3 were used instead of second silica particles B-1.

The toner of Comparative Example 1 was produced through a procedure similar to that for the toner of Practical Example 1 except that second silica particles B-4 were used instead of second silica particles B-1.

The toner of Comparative Example 2 was produced through a procedure similar to that for the toner of Practical Example 1 except that first silica particles A-3 were used instead of first silica particles A-1.

The toner of Comparative Example 3 was produced through a procedure similar to that for the toner of Practical Example 1 except that second silica particles B-5 were used instead of second silica particles B-1.

Table 1 lists, of the first and second silica particles contained in the toner of Practical Examples 1 to 4 and Comparative Examples 1 to 3, the types, the charge amount, the changing rate of the charge amount, the ratio of the absolute value of the initial charge amount of the second silica particles to that of the first silica particles, and the ratio of the change rate of the charge amount of the second silica particles between before and after hydrophobization treatment. Note that, with all of first silica particles A-1 to A-3, the change rate of the charge amount (the falling rate of the after-mixing charge amount to the initial charge amount) was 20% or more; accordingly, no experiments were conducted using the first silica particles of which the falling rate of the charge amount was below 20%.

TABLE 1

| | | | | | | | | | | | | Ratio of | |
|---|---|---|---|---|---|---|---|---|---|---|---|---|---|
| | | | | | | | | | | | | Absolute | Ratio of |
| | First Silica Particles A | | | | Second Silica Particles B | | | | Second Silica Particle Base B′ | | | Value | Change |
| | | | After | | | | After | | | After | | of Initial | Rate of |
| | | Initial | Mixing | Change | | Initial | Mixing | Change | Initial | Mixing | Change | Charge | Charge |
| | | [μC/ | [μC/ | Rate | | [μC/ | [μC/ | Rate | [μC/ | [μC/ | Rate | Amount | Amount |
| Toner | Type | g] | g] | [%] | Type | g] | g] | [%] | g] | g] | [%] | (B/A) | (B/B′) |
| Practical Example 1 | A-1 | 91.5 | 58.1 | −36.5 | B-1 | −17.8 | −11.1 | 37.6 | −50.7 | −30.7 | 39.4 | 19.5 | 95.4 |
| Practical Example 2 | A-1 | 91.5 | 58.1 | −36.5 | B-2 | −39.2 | −19.9 | 49.2 | −50.7 | −30.7 | 39.4 | 42.8 | 124.8 |
| Practical Example 3 | A-2 | 149.3 | 83.4 | −44.1 | B-1 | −17.8 | −11.1 | 37.6 | −50.7 | −30.7 | 39.4 | 11.9 | 95.4 |
| Practical Example 4 | A-1 | 91.5 | 58.1 | −36.5 | B-3 | −43.2 | −28.2 | 34.7 | −50.7 | −30.7 | 39.4 | 47.2 | 88.0 |
| Comparative Example 1 | A-1 | 91.5 | 58.1 | −36.5 | B-4 | −89.2 | −81.2 | 9.0 | −50.7 | −30.7 | 39.4 | 97.5 | 22.7 |
| Comparative Example 2 | A-3 | 102.1 | 40.0 | −60.8 | B-1 | −17.8 | −11.1 | 37.6 | −50.7 | −30.7 | 39.4 | 17.4 | 95.4 |
| Comparative Example 3 | A-1 | 91.5 | 58.1 | −36.5 | B-5 | −155.4 | −74.7 | 51.9 | −50.7 | −30.7 | 39.4 | 169.9 | 131.7 |

### [Evaluation of Image Density and Image Fogging]

For each of the toners of Practical Examples 1 to 4 and Comparative Examples 1 to 3, image density and image fogging (background fogging) were evaluated by the methods described below.

### (Image Density)

The toners of Practical Examples 1 to 4 and Comparative Examples 1 to 3 obtained in production example 3 were each installed in a developing portion of an evaluation machine (a monochrome printer, ECOSYS LS-4200DN, manufactured by Kyocera Document Solutions Inc.). After toner installation, in a normal-temperature normal-humidity environment (temperature: 23° C., humidity; 50% RH), a test image with a coverage rate of 5% was printed on 100,000 sheets. Immediately after the start of printing (initial) and after 100,000-sheet printing (after durability printing), the image density (ID) was measured using a reflection density meter (TC-6DX, manufactured by Tokyo Denshoku Co., Ltd.). The criteria for evaluation of the image density were as follows:
GOOD: ID≥1.3
POOR: ID<1.3

### (Image Fogging)

In the print results immediately after the start of printing (initial) and after 100,000-sheet printing (after durability printing), the fogging density (FD) in the blank background part around the image was measured using a reflection density meter (TC-6DX, manufactured by Tokyo Denshoku Co., Ltd.). The fogging density (FD) was calculated according to Expression (1) below.

FD=(Reflection Density in Blank Background Part on Printed Sheet)−(Reflection Density on Unprinted Sheet)

The criteria for evaluation of the image fogging were as follows:
GOOD: FD≤0.007
POOR: FD>0.007

Table 2 shows the results of evaluation of image density and image fogging with the toners of Practical Examples 1 to 4 and Comparative Examples of 1 to 3.

TABLE 2

| | Image Density [ID] | | | Image Fogging [FD] | |
|---|---|---|---|---|---|
| | | After | | After | |
| | | Durability | Evalu- | Durability | Evalu- |
| Toner | Initial | Printing | ation | Printing | ation |
| Practical Example 1 | 1.32 | 1.34 | GOOD | 0.002 | GOOD |
| Practical Example 2 | 1.34 | 1.31 | GOOD | 0.003 | GOOD |
| Practical Example 3 | 1.41 | 1.32 | GOOD | 0.005 | GOOD |
| Practical Example 4 | 1.34 | 1.34 | GOOD | 0.003 | GOOD |
| Comparative | 1.38 | 1.14 | POOR | 0.013 | POOR |
| Example 1 | | | | | |
| Comparative | 1.38 | 1.39 | GOOD | 0.010 | POOR |
| Example 2 | | | | | |
| Comparative | 1.17 | 1.11 | POOR | 0.003 | GOOD |
| Example 3 | | | | | |

Table 2 reveals the following. The toners of Practical Examples 1 to 4, in which the ratio of the absolute value of the initial charge amount of the second silica particles to that of the first silica particles was 10% to 50% and the falling rate of the charge amount of the first silica particles and the rising rate of the charge amount of the second silica particles between before and after mixing were 20% to 50%, all scored a good image density (ID) of 1.3 or more at an initial stage and after 100,000-sheet printing. In addition, they also scored a practically acceptable fogging density (FD) of below 0.007 after 100,000-sheet printing.

In contrast, the toner of Comparative Example 1, in which the rising rate of the charge amount of the second particles between before and after mixing was low, specifically 9.0%, and the ratio of the absolute value of the initial charge amount of the second silica particles to that of the first silica particles was high, specifically 97.5%, scored an image density (ID) of 1.14 after 100,000-sheet printing, and exhibited a drop in image density. It also scored a fogging density (FD) of 0.013 after 100,000-sheet printing, and exhibited image fogging. The toner of the Comparative Example 2, with a high falling rate of the charge amount of the first silica particles between before and after mixing of −60.8%, did not exhibit drop in image density but scored a fogging density (FD) of 0.010 after 100,000-sheet printing, and exhibited image fogging.

The toner of Comparative Example 3, with a high rising rate of the charge amount of the second silica particles between before and after mixing of 51.9% and a high ratio of the absolute value of the initial charge amount of the second silica particles to that of the first silica particles of 169.9%, scored an image density (ID) of 1.17 immediately after the start of printing and an image density (ID) of 1.11 after 100,000-sheet printing, and exhibited a drop in image density.

The above results confirm the following. When the ratio of the absolute value of the initial charge amount of the second silica particles to that of the first silica particles is 10% to 50%, by setting the falling rate of the charge amount of the first silica particles and the rising rate of the charge amount of the second silica particles between before and after mixing both to 20% to 50%, it is possible to provide magnetic one-component toner that can maintain image density after durability printing and that can also suppress image fogging.

The present disclosure finds application in positively chargeable magnetic one-component toner for use in electrophotography. Based on the present disclosure, it is possible to provide magnetic one-component toner that can, by stabilizing the chargeability of toner for a long period, suppress a drop in image density and suppress image fogging.

What is claimed is:

1. Magnetic one-component toner comprising a toner particle having:
a toner base particle containing at least a binder resin and a magnetic powder; and
an external additive attached to a surface of the toner base particle,
wherein
the external additive contains:
first silica particles with positive chargeability with respect to non-coated ferrite carrier; and
second silica particles with negative chargeability with respect to the non-coated ferrite carrier, and
when 10 g of the non-coated ferrite carrier and 0.1 g of the silica particles are weighed in a plastic bottle of 10 mL and mixed using a Turbula Shaker-Mixer to determine a charge amount after mixing for one minute as an initial charge amount, and a charge amount after mixing for 10 minutes as an after-mixing charge amount,
a ratio of an absolute value of the initial charge amount of the second silica particles to an absolute value of the initial charge amount of the first silica particles is 10% to 50%, and
a falling rate of the after-mixing charge amount to the initial charge amount of the first silica particles and a rising rate of the after-mixing charge amount to the initial charge amount of the second silica particles are both 20% to 50%.

2. The magnetic one-component toner according to claim 1, wherein
the second silica particles are obtained by subjecting wet silica particles to hydrophobization treatment with a titanate coupling agent.
